(19) United States
(12) Patent Application Publication
(10) Pub. No.: US 2011/0188763 A1
(43) Pub. Date: Aug. 4, 2011

(54) Image Header Compression Mechanism

(76) Inventors: Nenad Rijavec, Longmont, CO (US); Natalie D. Ross, Longmont, CO (US); Arianne T. Hinds, Louisville, CO (US)

(21) Appl. No.: 12/696,451

(22) Filed: Jan. 29, 2010

(51) Int. Cl. G06K 9/36; G06F 17/30

(52) U.S. Cl. 382/232; 707/802; 707/769; 707/693; 707/E17.044; 707/E17.014; 707/E17.019; 707/E17.002

(57) ABSTRACT

A computer system is disclosed. The computer system includes a database to store image files and a compression unit to compress the image files. The compression unit includes a cache controller to control caching of header components of an image file common to two or more image files stored in the database.

### FIELD OF THE INVENTION

The invention relates to the field of image storage, and in particular, to compressing image files for storage.

### BACKGROUND

Image hosting services allow individuals to upload images to an Internet website for storage at a server operated by a host. Such hosting services maintain large databases of images where image files are stored in a private format, and subsequently converted back to a standard viewable format when served by the database. The databases range from those with tightly controlled content, such as the Viewpointe check storage consortium, to medical imaging databases, and databases with almost unlimited variability (e.g., Flickr, Shutterfly, etc.). Even with the low cost of disk storage, the amount of data to be stored is often so large as to require a significant investment in purchasing, operating and maintenance of storage. Thus, operators of image hosting services typically must compress the images to reduce the size of stored images.

Image compression often requires that whatever reduction that is performed be lossless. When compressing, the content of an image file may be divided into actual image data and header information. To reduce the size of image data, entropy coding is usually implemented. However, the header information is typically compressed separately from the image using a lossless algorithm such as the LZW or a special-purpose algorithm that exploits the header structure.

However, since headers are getting bigger due to inclusion of additional information, such as International Color Consortium (ICC) profiles, there is a need to further compress the headers. Since current mechanisms compress each image separately, there is a need for a system that will leverage the aggregate information from the countless images available in an image database to achieve better compression.

### SUMMARY

In one embodiment a computer system is disclosed. The computer system includes a database to store image files and a compression unit to compress the image files. The compression unit includes a cache controller to control caching of header components of an image file common to two or more image files stored in the database.

In another embodiment a method is disclosed, including receiving an image file, determining if one or more header components within the image file is common to other header components stored in a database, and if so, caching the one or more header components.

In a further embodiment, a system is disclosed. The system includes one or more client computers a network communicatively coupled to the one or more client computers and a server communicatively coupled to the network. The server includes a database to store image files and a cache controller to control caching of header components of an image file common to two or more image files stored in the database.

### BRIEF DESCRIPTION OF THE DRAWINGS

A better understanding of the present invention can be obtained from the following detailed description in conjunction with the following drawings, in which:

FIG. 1 illustrates one embodiment of a data processing system network;

FIG. 2 illustrates one embodiment of a server;

FIG. 3A and 3B illustrate image file components;

FIG. 4 illustrates one embodiment of a cache compression unit;

FIG. 5 is a flow diagram illustrating one embodiment of a cache compression process; and

FIG. 6 illustrates one embodiment of a computer system.

### DETAILED DESCRIPTION

An image header compression mechanism is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

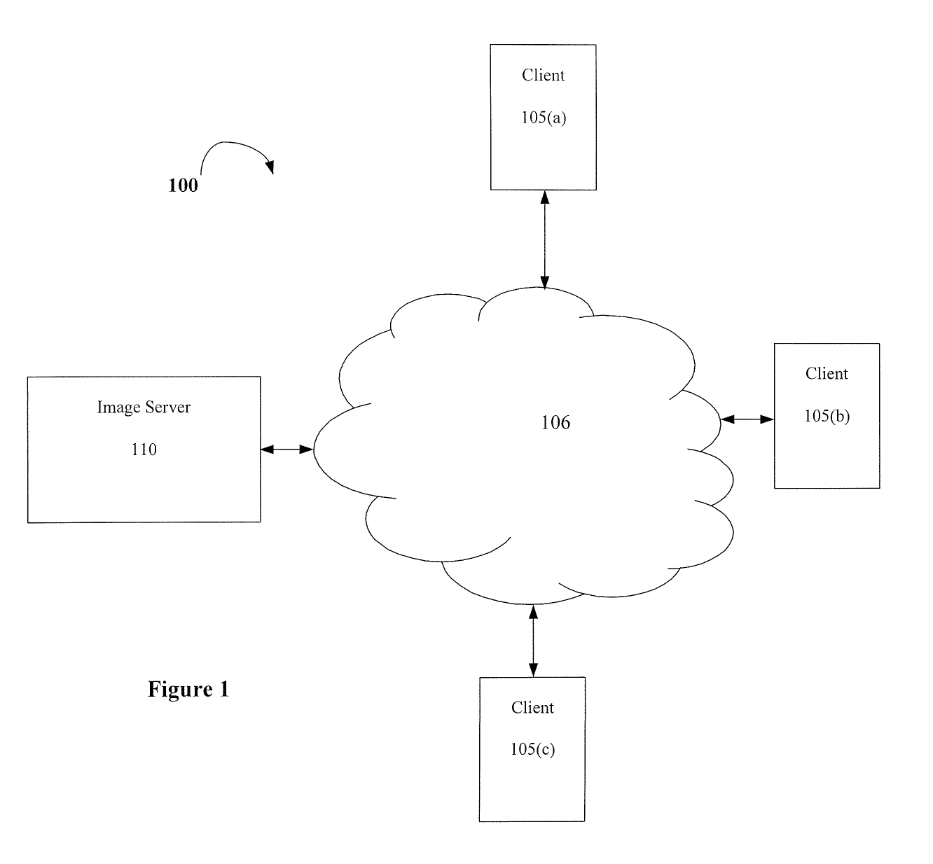

FIG. 1 illustrates one embodiment of a data processing system network 100. Network 100 includes an image server 110 coupled to clients 105 via a network 106. In one embodiment, clients 105 are data processing systems including a processor, local memory, nonvolatile storage, and input/output devices such as a keyboard, mouse, trackball, and the like, all in accordance with the known art.

Such data processing systems may be either a desktop or a mobile data processing system, coupled via a communications link to network 106. In a further embodiment, a data processing system includes and employs the Windows operating system, or other operating system, and/or network drivers a permitting data processing system to communicate with network 106 for the purposes of employing resources within network 106.

Network 106 may be a local area network (LAN) or any other network over which requests may be submitted to server 110. According to one embodiment, server 110 is an image hosting server that receives image files via network 106 from one or more of the clients 105 and stores the files in a database. Upon request, server 110 subsequently serves the images to clients 105 that are authorized to receive the images. For example, server 110 may store images uploaded by client 105(a). However, client 105(a) may share access to the images with clients 105(b) and 105(c). Thus, server 110 may serve those images to clients 105(b) and 105(c), as well as client 105(a).

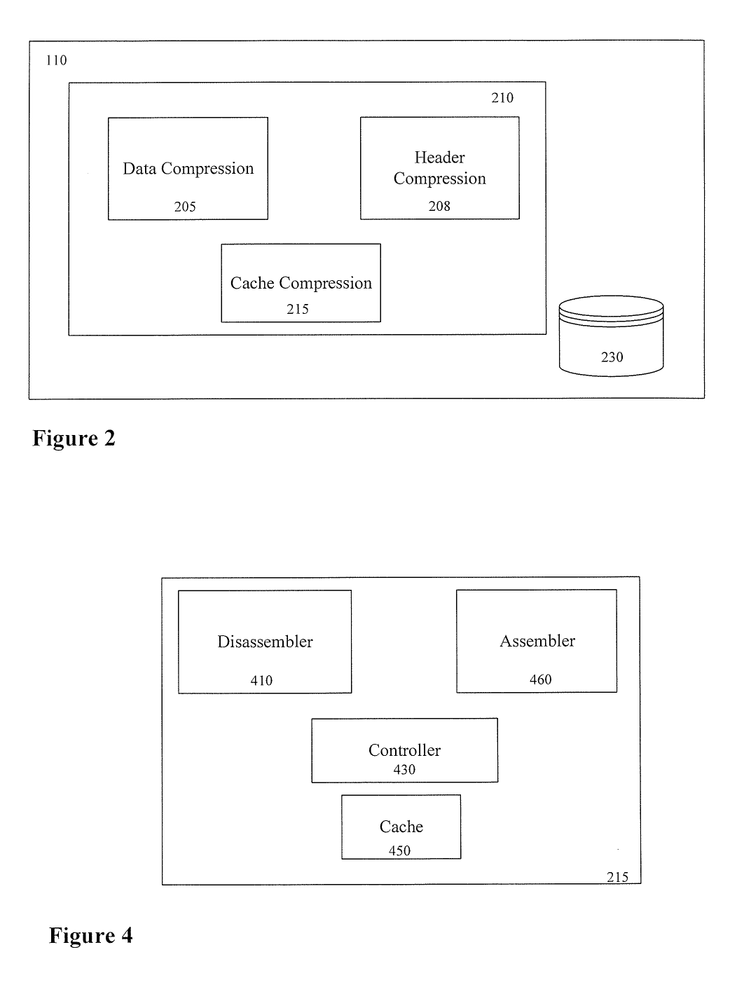

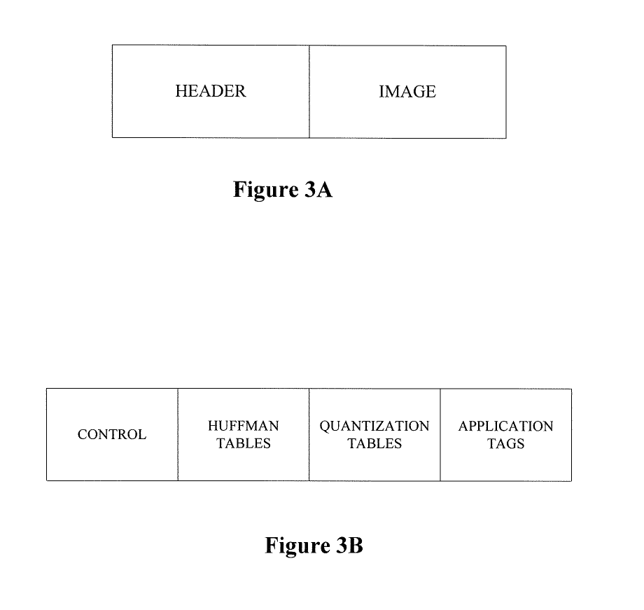

FIG. 2 illustrates one embodiment of server 110. Server 110 includes a compression unit 210 and database 230. Compression unit 210 compresses image files received at server 110. In one embodiment, each image file is separated into image data component and header information prior to compressing. FIG. 3A illustrates one embodiment of an image file having components header and image data components.

According to one embodiment, compression unit 210 includes a data compression unit 205 that compresses the image data components of an image file using entropy encoding. However, in other embodiments other lossless compression mechanisms (e.g., run length encoding, DPCM, etc) may be implemented. Similarly, a header compression unit 208 compresses the header information of the image file.

In one embodiment, header compression unit 208 compresses the header information using the Lempel-Ziv-Welch (LZW) lossless compression algorithm. Once compressed, the compressed components of the image file are stored in database 230. In addition to compressing each image individually, compression unit 210 includes a cache compression unit 215 to provide further compression by caching header information common to a multitude of the image files stored in database 230.

FIG. 4 illustrates one embodiment of a cache compression unit 215. Cache compression unit 215 includes disassembler 410, cache controller 430, cache 450 and assembler 460. Disassembler 410 separates header information into a plurality of components. Using JPEG as an exemplary embodiment, a JPEG file header includes a control information component, Huffman tables, quantization tables and application tags.

FIG. 3B illustrates one embodiment of an image file header components. The control information includes a small amount of variable data (e.g. width and the length data), while the remaining data is relatively fixed. For example, while JPEG allows a large variety of image data, most color JPEGs are YCbCr with 211 subsampling. Thus, the relevant parts of the control information in the header tends to be the same for most images.

Such header components are referred to as fixed components since there are likely to be many images stored in database 230 that share the same data. Similarly, the Huffman tables and quantization tables are also fixed. For instance, there are particular Huffman tables that are used in a large majority of images. While there is a larger variety of quantization tables, each table generator will only allow a limited number of different quality settings, where each quality setting is equivalent to a single quantization table.

Application tags may also have variable data. However, there are some tags that are fixed, such as the APP 14 tag used by Adobe to specify color information. Other tags include ICC Profiles that are fixed in the sense that many images will commonly have the same ICC Profiles. Finally, the header may include comment tags that are variable.

According to one embodiment, cache controller 430 caches the fixed header components at cache memory 450 after separation by disassembler 410. In such an embodiment, each component is cached using an appropriate access scheme. For example, both Huffman and quantization tables are relatively small. Thus, it may be feasible to search the cache directly. Similarly, the fixed components of the control information are likely to be fixed and easily searchable. In contrast, larger and less fixed components, such as the ICC Profile, may be identified using a hash such as a Message-Digest algorithm 5 (MD5) algorithm.

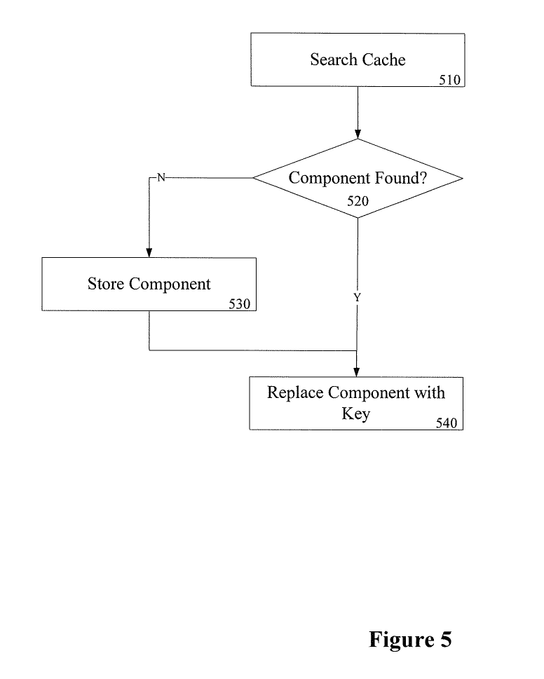

FIG. 5 is a flow diagram illustrating one embodiment of the operation of cache controller 230 for each header component during cache compression. At processing block 510, cache controller 430 searches for cache 450 the component. At decision block 520, it is determined whether the component is found in cache 450. If the component is not found, a copy of the component is stored in cache 450, processing block 530. In one embodiment, the component is stored in a lossless compression format implemented at header compression unit 208. At processing block 540, the component is replaced with a cache key. If the component is found in cache 450, or after a copy of the component is stored in cache 450, the component is replaced with the cache key, processing block 540. Subsequently, the cache key for the corresponding component is saved in database 230 as a part of the image file.

According to one embodiment, the header is stored in a private format that aggregates variable information such as the image dimensions and comment tags and a set of cache keys for the cached items. Thus when an image is retrieved from database 230, the header is reconstructed from the private format by reading and decompressing the specified cached components and merging the cached components with the compressed variable components at assembler unit 460 to generate the original image header.

In most embodiments, the header reconstruction is faster than the header compression since the user will usually have higher performance expectations when the image is recalled, while there is less requirement that the image be stored quickly. In further embodiments, a header may be small enough such that there is no benefit having the components cached. In such embodiments compression may be performed so that several of the fixed components may be concatenated with variable components into a single data set to improve compression ratios.

In yet a further embodiment, cache controller 430 watches for recurring unrecognized components. For example, numerous image files may be received at server 110 from a device that provides the device type and other fixed information into an application tag component. Cache controller 430 will thus recognize the repeated use of such information and begin to cache the information.

In still a further embodiment, special purpose compression schemes may be implemented to improve the compression of both cached and variable header component data. Since even variable components of headers are unlikely to be completely random given the large number of samples in the database, cache controller 430 may gather statistics on the information being stored in database 230 and use the statistics to generate a coding scheme, such as a variable length code or arithmetic coding to achieve even better compression.

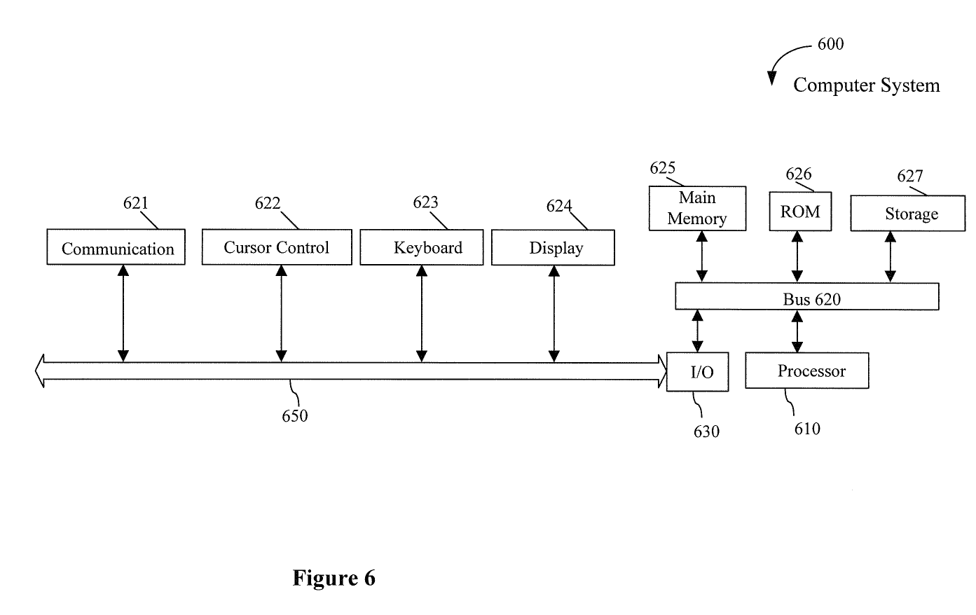

FIG. 6 illustrates a computer system 600 on clients 105 and/or server 110 may be implemented. Computer system 600 includes a system bus 620 for communicating information, and a processor 610 coupled to bus 620 for processing information.

Computer system 600 further comprises a random access memory (RAM) or other dynamic storage device 625 (referred to herein as main memory), coupled to bus 620 for storing information and instructions to be executed by processor 310. Main memory 625 also may be used for storing temporary variables or other intermediate information during execution of instructions by processor 610. Computer system 600 also may include a read only memory (ROM) and or other static storage device 626 coupled to bus 620 for storing static information and instructions used by processor 610.

A data storage device 625 such as a magnetic disk or optical disc and its corresponding drive may also be coupled to computer system 600 for storing information and instructions. Computer system 600 can also be coupled to a second I/O bus 650 via an I/O interface 630. A plurality of I/O devices may be coupled to I/O bus 650, including a display device 624, an input device (e.g., an alphanumeric input device 623 and or a cursor control device 622). The communication device 621 is for accessing other computers (servers or clients). The communication device 621 may comprise a modem, a network interface card, or other well-known interface device, such as those used for coupling to Ethernet, token ring, or other types of networks.

The above-described mechanism leverages aggregate information from millions of images stored in an image database to achieve improved compression. Although described with reference to JPEG, other embodiments include cache compression being implemented for other forms of image compression (e.g., Joint Bi-level Image Experts Group (JBIG), JPEG XR, JPEG2000, etc.) where collections of images are known to have originated under like conditions or are large enough that repeated patterns in header and other associated data are inevitable. These may include not only large photo-sharing services databases but also (for example) large medical imaging databases, geophysical and astro-image databases. For example, JPEG2000 allows a file to include information about the color space, copyright and other “metadata” information.

Moreover, the caching mechanism may be implemented by databases that store other types of data, such as video (e.g., YouTube), where an assumption of limited header variability is applied.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A computer system comprising:
a database to store image files; and
a compression unit to compress the image files, the compression unit comprising a cache controller to control caching of header components of an image file common to two or more image files stored in the database.

2. The computer system of claim 1 further comprising a disassembler to separate a header of the image file into header components prior to the cache controller caching the components.

3. The computer system of claim 1 wherein the cache controller searches a cache for each header component of a received image file.

4. The computer system of claim 3 wherein the cache controller caches a copy of a first header component not found in the cache.

5. The computer system of claim 4 wherein the cache controller replaces the first header component with a cache key.

6. The computer system of claim 5 wherein the cache key is stored in the database with the image file.

7. The computer system of claim 1 further comprising:
a data compression unit to compress an image data component of the image file; and
a header compression unit to compress the header components of the image file.

8. A computer generated method comprising:
receiving an image file;
determining if one or more header components within the image file is common to other header components stored in a database; and
if so, caching the one or more header components.

9. The method of claim 8 wherein caching the one or more header components comprises:
searching for a header component in a cache; and
caching the header component if the header component is not found in the cache.

10. The method of claim 9 further comprising:
replacing the header component with a cache key; and
storing the cache key in the database with the image file

11. The method of claim 9 further comprising:
replacing the header component with a cache key if the header component is found in the cache; and
storing the cache key in the database with the image file

12. The method of claim 8 further comprising separating the image file into an image data component and a header component upon receiving the image file.

13. The method of claim 12 further comprising separating the header component into a plurality of header components.

14. The method of claim 8 further comprising compressing the one or more header components.

15. A system comprising:
one or more client computers;
a network communicatively coupled to the one or more client computers; and
a server, communicatively coupled to the network, including:
a database to store image files; and
a cache controller to control caching of header components of an image file common to two or more image files stored in the database.

16. The system of claim 15 wherein the server further comprises a disassembler to separate a header of the image file into header components prior to the cache controller caching the components.

17. The system of claim 15 wherein the cache controller searches a cache for each header component of a received image file.

18. The computer system of claim 17 wherein the cache controller caches a copy of a first header component not found in the cache.

19. The computer system of claim 18 wherein the cache controller replaces the first header component with a cache key.

20. The computer system of claim 19 wherein the cache key is stored in the database with the image file.

21. The computer system of claim 15 wherein the server further comprises:
a data compression unit to compress an image data component of the image file; and
a header compression unit to compress the header components of the image file.
